(19) United States
(12) Patent Application Publication
(10) Pub. No.: US 2009/0246445 A1
(43) Pub. Date: Oct. 1, 2009

(54) THERMAL INSULATION PRODUCT FORMED FROM WASTE POLYSTYRENE

(76) Inventor: TIMOTHY E. PETERSON, BOISE, ID (US)

Correspondence Address: PEDERSEN & COMPANY, PLLC, P.O. BOX 2666, BOISE, ID, 83701, US

(21) Appl. No.: 12/056,883

(22) Filed: Mar. 27, 2008

(51) Int. Cl. B32B 3/02; B32B 27/06; B32B 17/10; B32B 37/00

(52) U.S. Cl. 428/68; 428/500; 428/339; 156/60

(57) ABSTRACT

A fire-resistant thermal insulation product may be used in new home construction and/or remodeling projects of existing buildings. Individual beads or small clusters of polystyrene (PS) beads are obtained by processing gleaned waste polystyrene through a plastics granulator or other cutting or grinding device. The PS beads and/or small clusters are coated with liquid intumescent fire retardant (FR) and dried. A binding solution is added, and the resultant FR-coated PS plus binder is compacted into self-supporting blocks. Each block is then dried, and subsequently placed in a polyethylene bag and sealed. The blocks are appropriately sized to fill the cavity spaces between wood and metal studs in both exterior and interior walls of buildings, between the ceiling joists in attics, and floor joists in crawl spaces. The width, thickness, and length of the solid rectangular shapes are variable, for example, varied for 16-inch-on-center and 24-inch-on-center framing spacing, and for various cavity dimensions and desired R-values. These insulation products meet the required safety test criteria, such as ASTM E84 and UL 94, necessary to meet building code requirements and ICC-ES certification.

### FIELD OF THE INVENTION

The present invention relates to building construction thermal insulating materials. More specifically, it relates to an insulation product made primarily from discarded/waste polystyrene foam that is coated with a fire retardant and preferably bound together in blocks suitable for insertion into building walls and/or ceiling spaces. In preferred embodiments, discarded/waste polystyrene foam is ground or chopped, coated with an intumescent fire retardant, and then bound into rectangular shapes with a binder that comprises recycled/recovered waste latex paint. The invention described here is engineered to be compatible with new home construction projects, or remodel projects, by meeting current building code requirements.

### PRIOR ART

The two primary types of thermal insulation materials used in home construction today are fiberglass and cellulose. Fiberglass insulation is produced from sand and some recycled glass, but it is energy intensive to produce. If it becomes compacted after being placed into use, it loses some of its insulation R-value. It has been suspected of possibly contributing to lung health issues, from inhalation of fibers. Cellulose uses mostly recycled newspaper in its production, but concerns have been raised that the newsprint ink that is removed contributes to water quality issues. Also, some feel that recycled paper could be put to a higher use in products that are currently using virgin wood and paper feed stocks. The brominated fire retardants used in cellulose insulation to render the product fire resistant are currently under scrutiny, especially in Europe and California, for possibly causing health problems.

While polystyrene is well known as an excellent thermal insulating material, it is as is also known to be easily ignited, to support the rapid spread of flames by the dripping of burning, molten resin onto the areas below where it is installed, and to produce toxic gases and smoke when burned. These, plus the expense of virgin expanded polystyrene (EPS), are the primary reasons polystyrene insulation is not utilized more in home construction. The present invention is engineered specifically to address these issues, with the aim of producing this insulation product in a cost-attractive manner. This is achieved by using problematic waste commodities and relatively low-cost non-commercial intumescent fire retardant formulations. The inventor's intent is to produce the polystyrene insulation product described on a national basis, developing the product to the scale of present fiberglass insulation and cellulose insulation productions.

Beads, pieces and chunks of polystyrene foam have been proposed to produce thermal insulation, in various forms and usage's for many years. In U.S. Pat. No. 3,118,194, issued Jan. 21, 1964, Maurice Biais proposed mixing polystyrene grains and lumps with a liquefied insulating powder to fill the space between the double-wall envelope surrounding storage or transporting tanks.

U.S. Pat. No. 4,134,242, Jan. 16, 1979, issued to Andrew Musz, describes granular free-flowing materials that could be installed in attic and wall cavities of buildings. Polystyrene is mentioned as one possible granular material that could be used, with the caveat that it should not be used when fire resistance is needed along with thermal insulation properties.

U.S. Pat. No. 3,598,672, issued Aug. 10, 1971, specifically proposes using “swelled polystyrene granules” mixed with a hardenable liquid binder material. The binder material is described as an epoxy resin.

Likewise, U.S. Pat. No. 3,154,604, U.S. Pat. No. 3,251,916, U.S. Pat. No. 3,577,363, U.S. Pat. No. 4,256,803, and U.S. Pat. No. 3,855,049 describe mixing polystyrene beads with 2-part binders, such as polyurethane resins, urea-formaldehyde resins, phenolic resins, or epoxy resins. These materials have not come into common use as home insulation, in part because of concerns the insulation product will off-gas VOC fumes after installation.

The products and methods of above patents do not eliminate the principal problems with polystyrene; namely it's easy flammability. The present invention does eliminate this problem, with the use of an environmentally-friendly, phosphate-based intumescent fire retardant that uses water for the solvent.

The prior art for the intumescent fire retardant preferably used in the present invention is reported in U.S. Pat. No. 4,265,963, issued to Dr. Ralph Matalon on May 5^{th}, 1981. The character of an intumescent fire retardant is described therein. But, again, the intumescent coating composition described in the Matalon patent to coat the polystyrene particles and board forms is a two-part liquid resin and hardener. The Matalon patent describes an energy-consumptive heating of the coated polystyrene beads in a suitable mold to cure the coating composition.

U.S. Pat. No. 3,955,987, issued May 11, 1976 to Schaar, et al, describes an attempt to develop a low-cost, water suspendible, phosphate-based intumescent coating. Their intent was to make a sprayable temporary coating that could be water-removed before or after fire contact. The preferred intumescent fire retardant formulation in the present invention is based on one of the 64 formulations presented in the Schaar, et al patent, but modified to be more water-resistant and more suitable for the proposed use.

Still, there is a need for an improved thermal insulation product that overcomes the problems associated with the prior art. Particularly, there is a need for an insulation unit that utilizes discarded/waste polystyrene, but that is fire-resistant and easy to store, carry, and install.

### SUMMARY OF THE INVENTION

The invention comprises thermal insulation that recycles/reuses waste polystyrene and, preferably, also latex paint to make panels, blocks, ingots, or pieces that may be installed inside walls, floors, ceilings, or other building structures. The invention comprises thermal insulation that is compliant with current building codes and that includes discarded/waste polystyrene treated for fire-resistance and preferably formed into blocks or ingots by use of one or more binder materials. In preferred embodiments, the fire-resistant coating comprises a binder component, such as methyl cellulose or other glue or water-resistant material, and the binder comprises waste/recycled latex paint or is entirely waste/recycled latex paint. The invented apparatus and methods may be used in wood and/or metal frame construction.

Each block or ingot, or a plurality of blocks or ingots, may be wrapped, sealed, or otherwise contained in a thin, flexible cover, such as a plastic bag or wrap, or may be coated with a paint-on covering such as latex paint for enhanced moisture-resistance. Alternatively, or in addition, the blocks or ingots may be placed into wall cavity spaces between the polymeric vapor barrier sheets typically erected inside said wall cavity spaces.

In preferred embodiments, waste polystyrene (PS) is broken down to individual beads and/or very small clumps of beads, which are then coated with an intumescent fire retardant that has been chosen because of ease of production and low cost and because it adheres well to the beads/clumps. The fire-retardant-coated PS beads/small clumps are then mixed with a binder solution comprising recycled/recovered waste latex paint. The addition of binder(s) is preferably, but not necessarily, done after drying of the fire-retardant on the PS beads/clumps. Subsequently, the fire-retardant-coated PS beads/clumps plus binder mixture may be placed into commercial baler equipment and baled into solid rectangular blocks, and/or may be otherwise compressed, molded, or extruded. When dried or nearly dried, these solid rectangular blocks are sealed in a plastic wrap/cover and are ready to be placed in the cavities formed between wall studs, exterior sheathing, and interior wall sheathing. They also may be used between ceiling joists in the attic, and floor joists in crawl spaces.

Alternative embodiments comprise the FR-coated PS beads/clumps being loose-filled into said wall or ceiling cavities. Binder optionally may be coated onto the beads/clumps, during or immediately before said loose-filling, for moisture resistance and/or for binding multiple of the beads/clumps together inside said cavities to prevent/limit slump inside the cavities.

### BRIEF DESCRIPTION OF THE DRAWINGS

FIG. 1 is a schematic portrayal of some, but not the only, steps that may comprise some embodiments of the invention.

FIG. 2 portrays some, but not the only, polystyrene waste products that may be ground or otherwise cut or pulverized into beads/clumps for embodiments of the invention.

FIG. 3 is a schematic portrayal of three main ingredients of some of the preferred, but not the only, embodiments of the invention, wherein polystyrene “grind” is coated with fire retardant and also with waste/recycled latex paint (or other binder(s)), to form a mix that may be shaped into the desired blocks, ingots, or other shapes for use as a code-compliant thermal insulation for building. While these three main ingredients are shown as being added together for a three-part mix, it is likely that they may be combined sequentially and/or in multiple steps, for example, coating the grind with fire retardant, followed at a later time in a batch process or downstream in a continuous process by addition of the binder. For example, the binder may be added immediately before, or during, a mixing step that coats each bead or clump so that all beads and clumps become connected by binder. Or, the binder may be added during a forming process, for example, into a port of a combined mixer/extruder. The binder is preferably not a thermoplastic binder that requires significant heat to liquefy the binder (followed by cooling to solidify the binder) or significant heat to cure the binder.

FIGS. 4-6 schematically portray one means of molding, but is not intended to portray all means of molding, baling, compressing, or otherwise forming a block of the thermal insulating product.

FIG. 7 illustrates one block of insulating product, according to some but not all embodiments of the invention, after it has been formed by binding of the FR-coated beads/clumps together into a single, self-supporting piece. The block in this figure is shown prior to addition of a bag, wrap, or other cover.

FIGS. 8-10 illustrate various sizes of blocks that are examples of embodiments of the invented insulation blocks, wherein these blocks are each encased inside a plastic/polymer cover.

FIG. 11 is one example of a wall construction that may use multiple blocks according to embodiments of the invention for providing thermal insulation between studs in a frame wall.

FIG. 12 is a partial, cross-sectional view of one of the blocks of FIG. 11, wherein the body of the block, formed from compressed and bound FR-coated PS beads/clumps, is shown inside a thin, flexible cover.

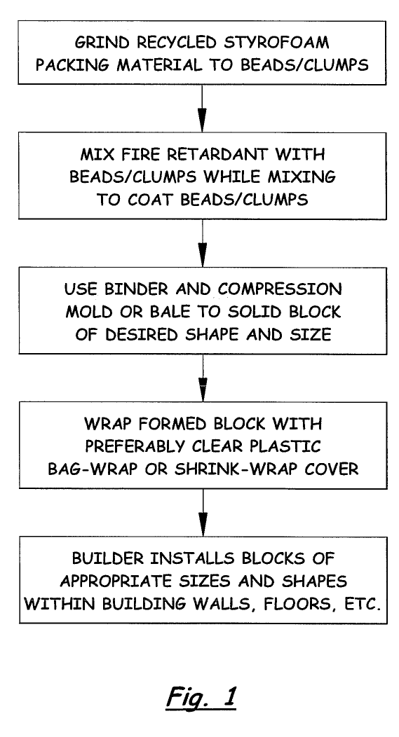

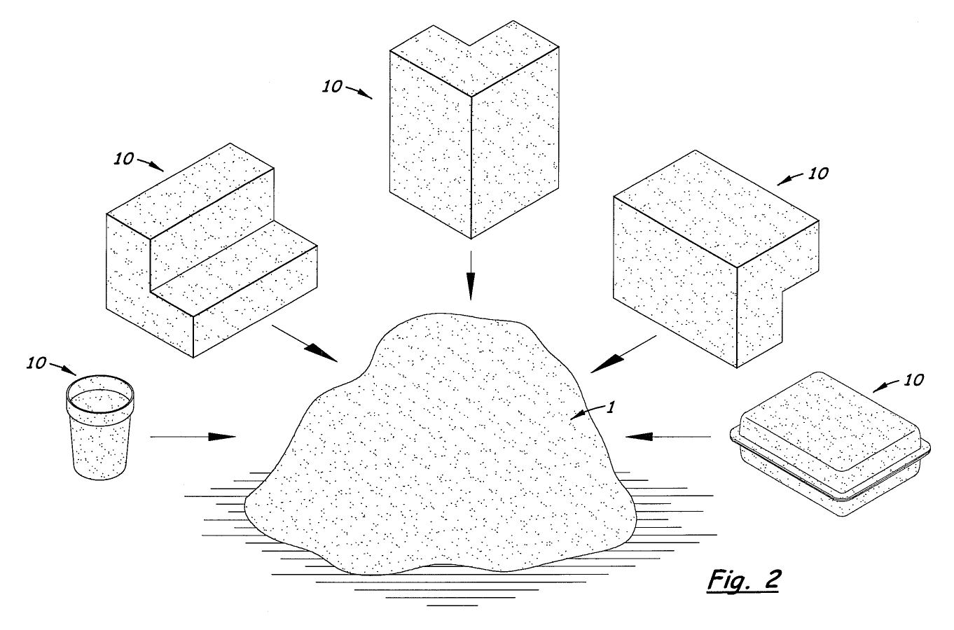

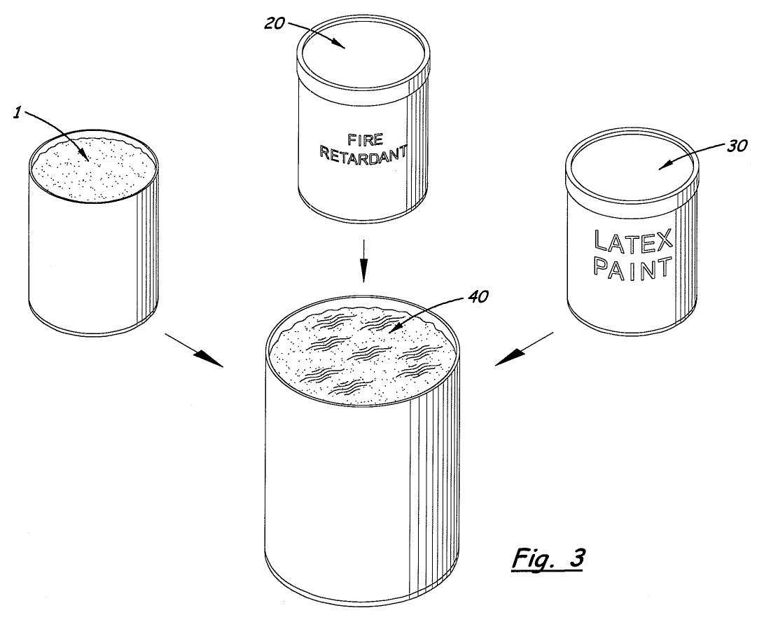

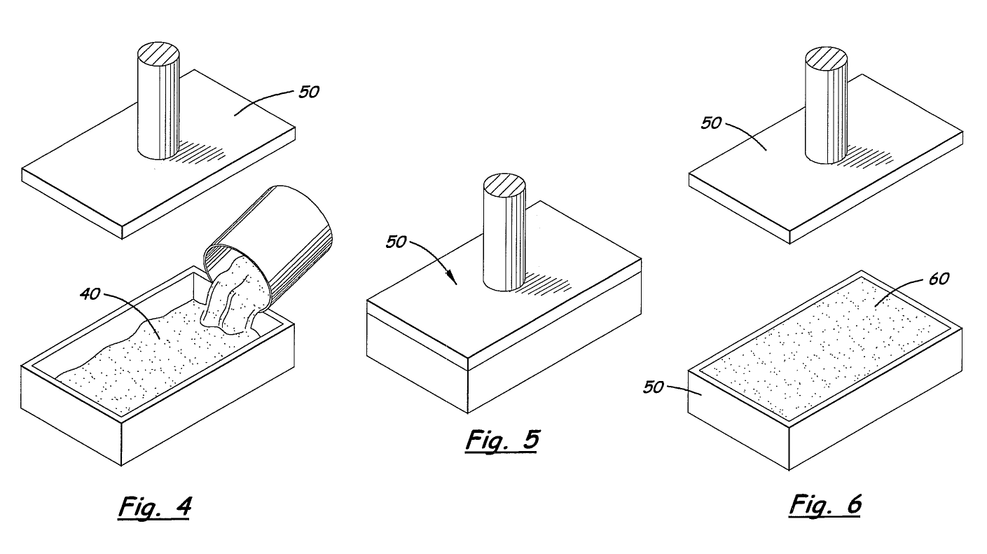

### DESCRIPTION OF THE PREFERRED EMBODIMENTS

Referring to the Figures, there are shown some, but not the only, embodiments of the invented thermal insulation product and/or methods of making and using said product. The preferred embodiments of the present invention are described below.

Polystyrene (PS) beads and/or small clumps 1 of PS are derived from primarily waste polystyrene, such as the polystyrene 10 from packing or cushioning or take-out cups or food containers, wherein the polystyrene is discarded when no longer needed. The EPA has estimated that in the year 2005, 2.59 million tons of expanded Polystyrene was produced and used in the United States, and less than 1,000 tons were recycled. Therefore, the inventor envisions that large amounts of waste polystyrene will be available locally in most communities. The inventor envisions, therefore, that embodiments of the invented products and methods may be effective in most communities without transporting additional polystyrene into said communities and will help solve a serious waste disposal problem.

The waste polystyrene may be processed in commercial granulating equipment equipped with outlet sizing screens, or in other cutting or grinding equipment. The sizing screens preferably have holes in the range of 0.1-1 inch in diameter, but more preferably approximately 0.250 inches in diameter, which allow the granulated particles to exit the granulating chamber when they have been broken down to the size of the holes. This granulated polystyrene, known as “re-grind” or “grind” in the polystyrene industry, is composed of particles including individual beads and/or small clumps of beads still bound together from their original molding. In the preferred process of the invention, the “grind” (beads/clumps 1) is conveyed to a storage bin arrangement or directly to fire-retardant-coating equipment.

The waste polystyrene grind is coated with a fire-retardant material(s), preferably by being mixed with, or sprayed with, liquid fire-retardant material(s). The mixing equipment may be commercially-available mixing equipment, such as, but not limited to, a turbine mixer, a ribbon mixer, a paddle mixer, a twin cone mixer, a single or twin screw extruder, a fluid bed coater/drier (either batch or continuous style), a pan coater/drier, etc. In a batch process for coating the PS grind with fire-retardant material(s), the polystyrene grind may be placed in the batch mixer in a pre-determined quantity, and, while being agitated by the mixer, may be sprayed with intumescent fire retardant (FR) 20 until the PS grind particles are uniformly coated with the FR. The mixture may be agitated until the FR coating has dried on the outer surface of the PS grind particles, optionally assisted by blowing dry, lightly heated air into the mixing chamber. Alternatively, in continuous processing, the polystyrene grind may be conveyed to a continuous mode mixer, for example, a turbine mixer comprising capability for metering and mixing one or more liquid components with the PS grind at one or more locations along the length of the mixing path. One example of a continuous mode mixer that may be effective is an Autocon Continuous Process OS-10 Mixer, available from Autocon Mixing Systems, Inc., which is a vertically-oriented, turbine mixer housed in a close-fitting cylindrical mixing chamber. As such a mixer is reported to be capable of solid/liquid, liquid/liquid, and dry blending applications, and may be fitted with multiple liquid inputs, it is expected to be effective for the desired process steps.

Drying of the fire-retardant material on the beads/clumps may take place inside the batch or continuous mixer, or may take place in a separate, preferably stirred or agitated, process tank or on a screen, conveyer or other surface, for example. It is preferred that the FR-coated beads/clumps be substantially dried in an environment that allows the coated beads/clumps to remain separate rather than sticking together. If the FR-coating process results in bound-together clumps that become broken apart in later processing steps, there may be polystyrene surfaces that become exposed in said later processing steps that are not coated with FR.

The dried or substantially-dried FR-coated PS grind may then be stored or conveyed immediately to the next step, which is a binder-addition step. The dried or substantially-dried FR-coated PS grind is mixed or sprayed with binder solution 30 (preferably, waste latex paint), for example, in a batch mixer, a second continuous mixer, or as a downstream step in the same continuous mixer as is used for coating with fire retardant. If the FR-coated PS grind has been dried or substantially dried in the continuous mixer (for example, by air stream injection midway along the mixing path), the FR-coated PS grind may proceed, without exiting the continuous mixer, to a down-stream region of the continuous mixer wherein one or more binder materials are injected. In this way, the fire-retardant coating, drying, and binder addition may be done in a single continuous mode mixer or at least in series-flow, continuous mixing steps. The result of the binder-addition step is to form a mix 40 of binder plus FR-coated PS beads/clumps.

The FR-coated binder/grind mix 40 is then directly introduced into the commercial compaction baler equipment or other compressing, molding 50 or extruding equipment. The baler equipment may be of the type used to package wood shavings for pet bedding, or peat moss for home garden use. The mixture is compacted into solid rectangular shapes 60, which are called “solid” because they are at least substantially solid throughout and have a consistency and strength that allows them to be self-supporting; small gas/air pockets or void spaces may be present, however, as long as such pockets/spaces are not sufficient to significantly diminish the R-value of the product. The shapes 60 are then dried, and then preferably sealed in plastic, such as polyethylene bags, for example, resulting in the final thermal insulation product 100, 101, 102, 103. Compression baling systems, such as a Willems-Techniek baler available from Creative Packaging, Inc., Lookout Mountain, Tenn., are expected to be effective for the desired process steps. The rectangular shapes 60, or other block shapes formed in the baling, compaction, or other molding step, are preferably self-supporting, or substantially self-supporting, prior to being encased in the flexible plastic cover and remain self-supporting or substantially self-supporting, after being encased. Alternatively, encasements other than plastic bag/wrap may be used, for example, more ecologically-friendly materials or recycled materials, however, the encasing material preferably is not a rigid box or rigid container or any other container of thickness more than about 50 millimeters in thickness.

The preferred embodiment is a solid rectangular shape sealed in plastic with specific dimensions designed for use in building construction. When the product is to be used in conventional 2×4, 16-inch on center, 8-foot tall wall construction, the external dimensions would be 14.5 inches wide×3.5 inches thick/high, and approximately 23.5 inches long. For 2×6 inch, 24-inch on center, 8-foot tall wall construction, the external dimensions of the compressed block would be 22.5 inches wide, 5.5 inches thick/high, and 23.5 inches long. Other dimensions may be also designated for specific needs, such as corner wall cavities that may be narrower/smaller than the above dimensions, or as dictated by ceiling joists or floor joist dimensions.

One may note from the above discussion of the preferred methods, that the PS grind preferably consists of small particles that are individual original-manufacture polystyrene beads, clumps of said polystyrene beads, or clumps of polystyrene that comprise whole beads plus shards of beads. By grinding the waste polystyrene to small diameter beads or clumps, the fire-retardant coating procedure results in a high amount of fire-retardant surface area per volume of polystyrene, and, preferably, no external surface area of polystyrene beads/clumps that is not coated with fire-retardant. The preferred embodiments result in high surface area to volume ratio for the polystyrene, wherein all or substantially all of said surface area is coated with the fire-retardant.

The preferred methods comprise drying or substantially drying the fire-retardant-coated PS grind prior to mixing with binder. This prevents or limits mixing of the fire-retardant and the binder, with the goal of maximizing the effectiveness of the fire-retardant while providing a moisture-resistant or moisture-proof coating for the fire-retardant that also binds the beads/clumps together in a self-supporting form.

The preferred embodiment of the intumescent fire retardant is as follows.

| | Preferred | |
|---|---|---|
| | Embodiment | Ranges |
| | (weight basis) | (weight basis) |
| Ammonium Polyphosphate (APP) | (2 parts) | 1-4 parts |
| Mono-ammonium Phosphate (MAP) | (3 parts) | 1-4 parts |
| Corn Starch | (1 parts) | 1-4 parts |
| Urea | (2 parts) | 1-4 parts |

| | |
|---|---|
| Methyl cellulose, | 4-400 gms/1000 gms mixture. |
| (Wall Paper Sizing, WPS) | |

Thus, one may see from the above list that, of the four-component fire retardant mixture (all listed as weight-% and prior to adding of WPS), APP is preferably approximately 25% of the mixture (typically in the range of 20-30%), MAP is approximately 37.5% of the mixture (typically in the range of 32-42%), corn starch is approximately 12.5% of the mixture (typically in the range of 7.5-15%), and urea is approximately 25% of the mixture (typically in the range of 20-30%), for a total of 100% mixture. Then, WPS is added in the above ratio to the mixture. These proportions may be changed, for example, with components provided in a range of approximately 5% up to approximately 45% and the mixture being a total of 100% prior to addition of the WPS.

The preferred intumescent fire retardant (FR) may also be described as a phosphate based, water soluble composition that has been modified by adding binder component(s) that make(s) the FR coating more resistant to water degradation after the composition has been dried. The preferred FR is comprised of ammonium polyphosphate (1-70% by weight); mono-ammonium phosphate (1-70% by weight); a starch product (corn, potato, sugar, etc., 1-50% by weight); Urea, (1-50% by weight); and a methyl cellulose product (0.1-25% by weight); wherein this mixture is then combined with enough water to attain 20-80 wt-% (more preferably, 50-60 wt-%) load of solids in the water. The binder component in the FR composition above is the methyl cellulose, and is preferably used in addition to the binder that binds multiple of the FR-coated PS beads/clumps together during or immediately prior to baling, molding, extruding or other compression or forming of blocks. Thus, it may be said that, in many embodiments, the FR binding component improves adherence of the FR to the beads/clumps and helps retain the FR on the beads/clump surfaces even in moist or wet environments, and that additional, separate binder(s) are provided to bind together the FR-coated beads/clumps and to provide additional moisture-resistance.

Other effective intumescent fire-retardant liquids may be formulated for use in embodiments of the invention, for example, according to prior art recipes, however, the above composition is preferred because it is low-cost and easy to make and has at least some water-resistance. The term “intumescent fire-retardant” material means fire retardants that act by producing, when exposed to heat, swelling (and lower density) and/or an ash or char, thus, retarding or preventing further singe, fire, flame, and spread of fire by dripping of burning polymer. Intumescent fire-retardant materials for embodiments of the invention may be selected, for example, from those described in U.S. Pat. No. 4,265,963, issued to Dr. Ralph Matalon on May 5^{th}, 1981, or U.S. Pat. No. 3,955,987, issued May 11, 1976 to Schaar, et al. The preferred intumescent fire-retardants are phosphate-based and water-soluble intumescent fire retardant(s). The intumescent fire-retardant used in the present invention is preferably not of the type that releases water or water vapor when exposed to heat/flame.

Intumescent coatings have also been described in technical literature as fire-resistant coatings that expand to form an insulating and fire-resistant covering when subjected to heat, wherein the coatings preferably contain interdependent components, including 1) spumific compounds, which (when heated) release large quantities of non-flammable gas (such as nitrogen, ammonia, CO2; 2) a binder that is adapted so that (when heated) it melts to provide a thick liquid, thus trapping the released gas in bubbles and producing a thick layer of froth; and 3) an acid source and a carbon compound, wherein upon heating, the acid source releases phosphoric, boric, or sulphuric acid that chars the carbon compound, casing the layer of bubbles to harden and produce a fire-resistant barrier (wherein said binder of (2), above, can serve as the carbon compound). Intumescent fire-retardant coatings according to this description may be included in embodiments of the invention. In view of the above description that considers a component of intumescent fire-retardants to be a “binder” forming a thick liquid to trap released gas and produce a thick layer of froth, the methyl cellulose of the preferred FR may be considered “an additional binder” or “a binder adapted to retain the FR on the beads/clumps, including in moist environments.” In other words, in addition to the binder described above for trapping gasses and forming froth, the preferred embodiment includes an additional binder that is adapted for retaining the intumescent fire-retardant on the beads/clumps.

The binder solution/suspension may be comprised of (but not limited to) recycled/recovered waste latex paint. Preferably, the binder is 100% latex paint, wherein the term “latex paint” is used as is familiar to those of skill in the art of paints for building room surfaces, latex paints being paints that have a latex component (also sometimes called “rubber-based”paint) that are used for covering wall, ceiling, or floor surfaces for decoration or providing a finished appearance to a room surface, typically including adding color to the room surface chiefly for the sake of appearance. Large volumes of recycled or waste latex paint are available, either due to overstocking, overproduction, or other waste. Some recycled latex paint is filtered or otherwise treated and then blended to produce recycled paint that can be of interest to those who are not particular regarding the color of the paint. Still, large volumes of latex paint are typically dumped or otherwise wasted, sometimes resulting in environmental problems. The preferred embodiments may utilize this otherwise-wasted latex paint for an excellent, low-cost binder that does not significantly add to the fire hazard of the invented material.

Alternately, the binder solution/suspension may be methylcellulose mixed in water or latex paint in a proportion of 80-200 grams (more preferably, 100 grams) per 1,000 grams of water and/or latex paint (preferably, waste latex paint). Such binder embodiments utilize these materials also for an excellent, low-cost binder that does not significantly add to the fire hazard of the invented material. Other binder solutions/suspensions that are envisioned, preferably selected from those that do not interfere with the function of the fire-retardant coating(s) and preferably selected from recycled and inexpensive materials.

### EXAMPLES

Waste polystyrene is ground to beads/clumps preferably less than 0.5 inches in diameter and preferably greater than 0.10 inches in diameter. Most preferably, the clumps are approximately 0.25 inches in diameter. Preferably, polystyrene “dust” and tiny particles are not formed or are minimized, as these create more waste and/or breathing hazard. The waste polystyrene may be selected, for example, from blocks used to cushion computer components or furniture for shipping, or from cups or food containers. Hence, the waste polystyrene is typically on the order several inches or feet in each dimension. Polystyrene cups or food containers are preferably washed prior to being ground into beads/clumps.

One or more fire-retardant liquids are mixed with the ground PS, with the preferred fire-retardant liquids being one or more intumescent fire-retardants, and, most preferably, the fire-retardant described above. The fire-retardant recipe above may be modified and/or have additional components included in it, within the general goals of the fire-retardant being low-cost, fire-retardant, easily-dried on the surface of the PS, and relatively safe to make and handle. It is beneficial if the dried fire-retardant tends not to become dissolved in the binder material and tends not to be easily worn away from the PS beads/clumps during subsequent mixing with binder and/or baling, molding, or extruding.

The one or more fire-retardant liquids are then mixed with the PS grind, preferably in the proportion of 1-40 vol-% FR to grind, and more preferably, 5-20 vol-% FR to PS grind. Preferably after drying of the one or more fire-retardant on the external surface of the PS grind beads/clumps, the FR-coated PS grind is mixed with one or more binders, preferably of the types discussed above (100% latex paint, latex paint with other binders, or methyl cellulose in water and/or latex paint). The FR-coated PS grind is mixed with the one or more binders preferably in the proportion of 1-25 vol-% (more preferably 1-10 vol-%) binder in FR-coated PS grind.

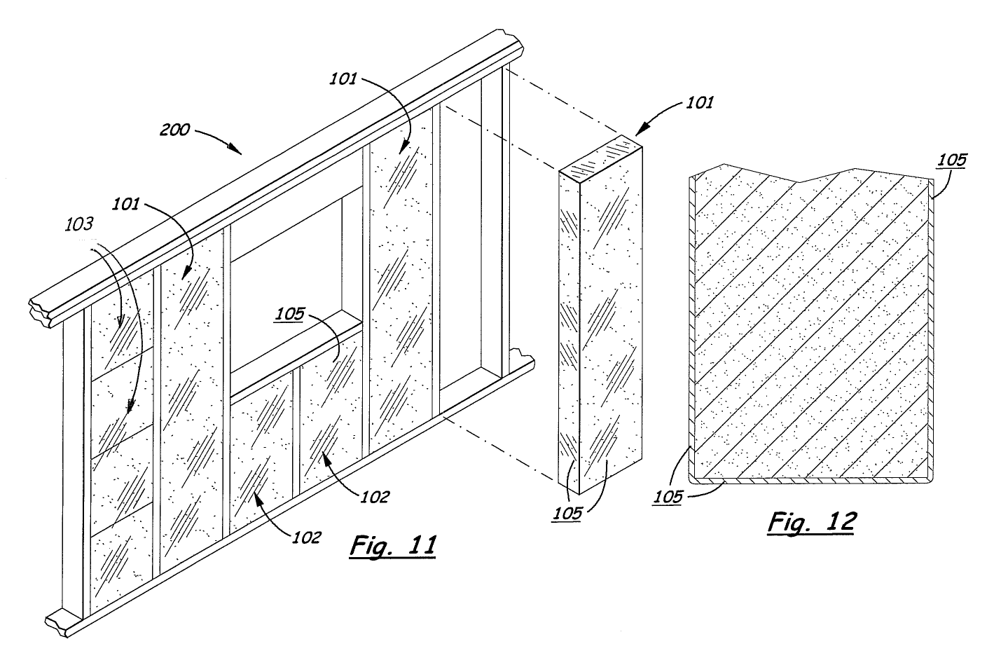

After mixing with one or more binders, the mixture is then baled, compressed, molded, extruded or otherwise formed into the desired solid or substantially solid shapes. “Solid” or “substantially solid” herein means that the shape is generally continuous and not hollow, but that is may have some air pockets or bubbles or other non-uniformities or discontinuities. The resulting blocks or extrudates are preferably each at least 3.5 inches in at least one dimension, and, more preferably, at least 3.5 inches in one dimension and substantially greater in at least one other dimension. As noted above in the document, especially-preferred embodiments are unitary blocks that fit snugly in the space/cavity between studs in a wall and that extend for many inches along said space/cavity between the studs. Thus, for any one space/cavity between studs, single blocks may extend all the way between two studs, as shown by the insulation products 101, 102, 103 in the insulated wall assembly 200 of FIG. 11. A single block also may be formed to fill the entire length space/cavity, extending from stud to stud and from top to bottom of the space/cavity as shown by insulation products 101, 102 in FIG. 11. Alternatively, in order to make handling of the blocks easier, smaller blocks may be formed for stacking in the space/cavity preferably to entirely fill the entire length of the space/cavity from stud to stud and from top to bottom. There may be “joints” or small gaps between vertically-stacked blocks (such as the approximately 22½ inch tall blocks 103 in FIG. 11, wherein four blocks 103 fill a typical wall cavity), which joints/gaps may be filled with expanding foam or other sealants or caulking, for example.

FIG. 11 illustrates one embodiment of frame construction wall, wherein it is understood that the studs and other members defining the wall cavities are typically wood products. However, it should be understood that the preferred embodiments shown and described in this Description may also be used as thermal insulation in other methods of construction, for example, metal frame construction, wherein the studs and other “framing members” that define the cavities may be metal and/or other materials.

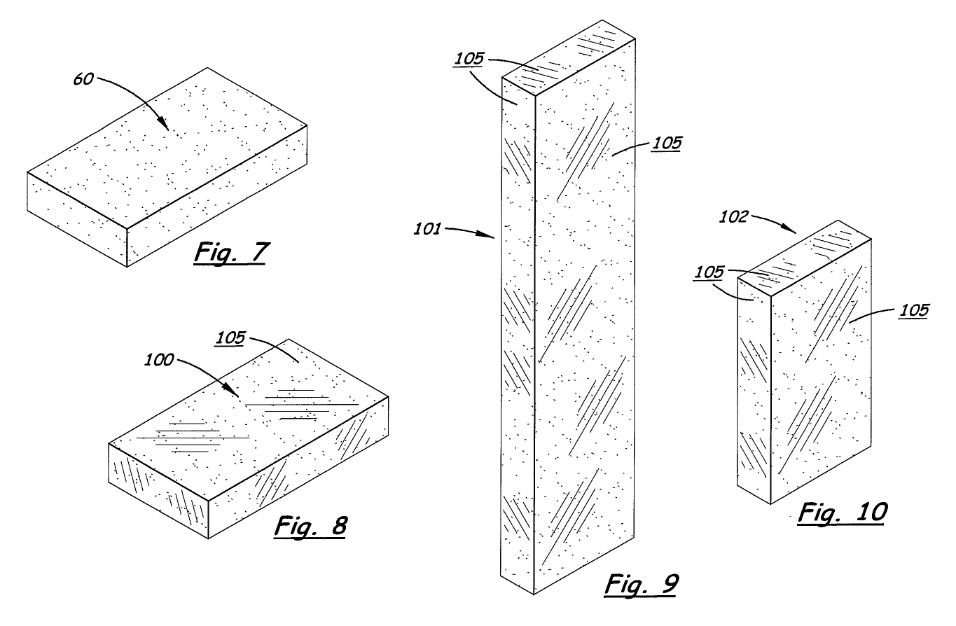

The covering 105 for each block is preferably a polymeric “plastic” thin layer, such as a plastic bag or other material that is flexible and that may encase the block without necessarily adhering to the block. Thus, as shown in FIG. 12, the block of baled or molded (preferably slightly compressed and held in a self-supporting shape by binder) fire-retardant-coated PS has a wrap or cover around it to help prevent damage or wetting of the block surface and to help prevent chips or flaking of the block surface material. The wrap/cover is preferably not attached or stuck to the block material, except by virtue of surrounding the block on all sides and being closed/sealed so that there are no holes in the wrap/cover. In FIGS. 8-11, the cover 105 is called-out as the surface of the block product 100, 101, 102, 103 and it will be understood that the cover 105 forms a thin outer layer/surface for the product 100, 101, 102, 103 that is preferably not adhered to the PS block, but that is close-fitting and thin.

Alternatively, after mixing the PS beads and/or small clumps with the intumescent FR in the mixing equipment and adding binder solution, as described above, the wet mixture may be fed into an extruder, single screw or twin screw, which would extrude the mixture through a die that would shape the output mixture in a compressed bar or “ingot” form of dimensions approximately those of the wall cavities, ceiling joists cavities, and/or floor joists cavities. For example, the compressed ingots may be 14.5 or 22.5 inches wide (to fit various stud or joist spacings). The length dimension of the ingots would be obtained by cutting the extruded form at a pre-determined interval, for example, for 22 inch, 4 foot, or 8-15 foot ingots. Next, the ingots could be coated with recycled waste latex paint to provide water resistance to the ingot (in addition to any latex paint that may be in the binder). These ingot shapes could be dried and optionally also sealed in plastic as previously described, if desired.

Alternatively, extruding, baling, or molding of the binder plus coated-PS grind may produce various (including non-rectangular) smaller shapes of the thermal insulation according to embodiments of the invention, wherein the block shapes are preferably also at least 3.5 inches in one dimension, but which are typically less than or equal to 12 inches in their greatest dimension. Multiple blocks may be preferably stacked or layered (so as to prevent or limit open, empty gaps) inside the space between studs that has been pre-lined with vapor barrier sheets. As is common in construction of wood frame buildings, for example, wall cavity spaces are often sealed on the interior side with a 6-mil polyethylene vapor barrier. Typically, these various smaller shapes will also be individually wrapped or covered with plastic, or may be painted with latex paint (in addition to any latex paint in the binder), or, less preferably, may rely on the vapor barrier for moisture-resistance and for being “sealed” in the wall.

Alternatively, the previously-described FR-PS beads/clumps, without being baled, molded, or otherwise formed after grinding, could be blown, poured, etc. into the wall cavity after the vapor barrier has been erected, through a small slit or hole in the vapor barrier. The loose-fill product may be poured\blown into the top of the cavity, so that it falls to the bottom to fill the cavity from the bottom to the top. Alternatively, the FR-PS beads/clumps may be blown into the cavity from a centrally-located slit or hole in the vapor barrier to fill the cavity from its outer perimeter to the center. The loose-fill product is preferably loaded into the cavity by methods that result in a dense bed with minimized interstitial spaces between the beads/clumps. Such embodiments of the FR-PS beads and/or small clumps may comprise adding binder solution to the FR-PS beads/clumps just prior to the beads/clumps, being poured/blown into the wall cavity, with waste latex paint as the preferred binder, in order to prevent or limit slumping of the beads/clumps in the cavity. In such methods, binder drying time may be required before sealing the cavity. Alternatively, no binder may be added at the time of installation of the loose-fill insulation in the wall cavity, that is, the loose-fill is installed/placed “dry.” In such dry installations, PS beads and/or clumps placed in the wall cavity do not require additional time for drying before being sealed in the wall, and the interior sheathing, typically ½-⅝ inch gypsum board, can be put in place immediately after the loose-fill is installed.

Thus, the basic element of the preferred embodiments is the FR-coated PS beads and/or small clumps. One or more binder components is/are preferably included in the FR material that is coated onto the PS beads/clumps. In addition, at least one additional layer surrounding the beads/clumps is provided, for one, and preferably both, of the following purposes: binder to bind multiple of the beads/clumps together into a larger shape, and/or binder to provide water-resistance or water-proofing. Ideally, the binder binds the beams/clumps into medium or large blocks, that may be easily and economically covered in a plastic bag, and that are easy and neat to handle and install, but other embodiments, as discussed above, may be effective. Blocks may be custom-shaped and sized to fit in particular cavity, for example, by opening the plastic bag, cutting portions of the block away, and then rewrapping and sealing the remaining custom-shape or custom-size block.

Some embodiments may be described as an insulation product suitable for new and/or remodel home construction projects, the product being comprised of waste polystyrene (PS) that is granulated to individual bead and/or small clump size and then coated by physically mixing the beads/clumps with a phosphate-based, water-soluble intumescent fire retardant. The mixing equipment used for coating fire-retardant into the PS beads/clumps may be commercially available equipment such as continuous mixers, continuous turbine mixers, ribbon mixers, twin cone mixers, paddle mixers, or similar equipment. The fire-retardant-coated beads/clumps may then be dried while continuously being agitated in the mixing apparatus, followed by providing of a binder material. The binder material may be selected from binders comprising or consisting of waste latex paint, wherein the binder coating is applied to the PS beads and/or small clumps while being agitated in the mixing equipment or immediately prior to being agitated in mixing equipment. The binder plus fire-retardant-coated-PS-beads/clumps (wet mixture of FR-PS beads/clumps with binder) may be compressed into solid rectangular shapes by compaction equipment, for example, a commercially-available compaction baler. Each compacted, solid rectangular shape may be allowed to dry, and then sealed inside a plastic bag that is close to, and conforms to, the outer surface of the rectangular shape all the way around said rectangular shape.

In simple forms, the invented thermal insulation block for wood or metal frame building construction, may be described as consisting essentially of, or consisting only, of ground recycled polystyrene comprising polystyrene beads and clumps; a coating of intumescent fire-retardant on each of said beads and clumps; and a binder material comprising latex paint holding said beads and clumps coated with intumescent fire-retardant together in a self-supporting block. Most preferably, the binder material is at least 90 vol-% recycled latex paint. The intumescent fire-retardant may comprises methyl cellulose, other glue material(s), or a mix of glues and/or methyl cellulose. The binder material may, in some embodiments, consist essentially of, or consist only of, recycled latex paint, or of recycled latex paint plus methyl cellulose.

A wall construction may include embodiments of the invented insulation block, wherein the wall comprises multiple framing studs with wall cavities between said studs and in front of exterior sheathing (so that the studs form the lateral sides of each wall cavity and the exterior sheathing forms the back of each wall cavity), and wherein sealed, compressed solid rectangular shapes according to the preferred embodiments of the insulation blocks are received in said wall cavities. Interior sheathing, such as gypsum board, may constitute the fourth (front or inside) wall of each wall cavity, which interior sheathing is installed after placement of the insulation blocks inside the wall cavities.

A ceiling construction may include embodiments of the invented insulation block, wherein the ceiling comprises multiple ceiling joists above a gypsum board ceiling, so that the joists and gypsum board define ceiling cavities between said ceiling joists. Sealed, compressed solid rectangular shapes according to the preferred embodiments of the invented insulation blocks are received in said ceiling cavities.

A floor construction may include embodiments of the invented insulation block, wherein the floor comprises multiple floor joists with floor cavities between said floor joists, and wherein sealed, compressed solid rectangular shapes according to the preferred embodiments of the invented insulation blocks are received in said floor cavities in crawl spaces.

The insulation product provided in said wall, ceiling, and/or floor assemblies may comprise polystyrene starting material comprising mainly, or consisting entirely of, waste polystyrene gleaned from businesses, manufacturers, government entities, or individuals. The polystyrene may be recovered salvage, or otherwise not-newly-manufactured virgin expanded or extruded polystyrene. The starting polystyrene is granulated to individual bead-size, or small clump-size, by commercially-available granulators, hammermills, or other mechanical device intended for size reduction of plastics and polymers. Such a size-reduction device incorporates an outlet sizing screen with sizing holes preferably in the range 0.125-1 inches in diameter. Particularly-preferred size-reduction devices incorporate an outlet sizing screen with sizing holes approximately 0.25 inches in diameter.

The intumescent fire retardant component (FR) described may be a phosphate based, water soluble composition that has been modified by adding a binder solution which makes the FR coating more resistant to water degradation after the composition has been dried. The FR may be comprised of ammonium polyphosphate (1-70% by weight); mono-ammonium phosphate (1-70% by weight); a starch product (corn, potato, sugar, etc., 1-50% by weight); Urea, (1-50% by weight); and a methyl cellulose product (0.1-25% by weight); wherein this mixture is then combined with enough water to attain a 20-80% wt-% (preferably 50-60% wt) load of solids. In addition to the FR comprising a binder such as methyl cellulose, the FR-coated PS beads/clumps are further mixed, after drying of the FR on the beads/clumps, with a binder material that is comprised of methylcellulose 0.5-10% in water, or methyl cellulose 0.5-10% in water combined with recycled latex paint, or just recycled waste latex paint.

As an alternative to compress or otherwise formed self-supporting blocks, the FR-coated PS beads or small clumps of beads may not in any later step be compressed into solid rectangular shapes, but instead the FR-coated PS beads/small clumps may be used as a blow-in loose-fill insulation product in walls. In said loose-fill embodiments, binder, such as waste latex paint or methyl cellulose in latex paint, may be added at the time of installation, to help prevent slump and the consequent major gaps in insulation. Alternatively, the loose-fill beads/clumps may be dry-filled. Netting or plastic sheeting may be attached to the interior surface of wall studs, then said loose-fill product may be blown into the cavity formed between the two lateral wall studs, the exterior sheathing, and the interior side netting or plastic sheeting.

Although this invention has been described above with reference to particular means, materials and embodiments, it is to be understood that the invention is not limited to these disclosed particulars, but extends instead to all equivalents within the broad scope of the following claims.

I claim:

1. A thermal insulation block for wood or metal frame building construction, the block comprising:
ground recycled polystyrene comprising polystyrene beads and clumps;
a coating of intumescent fire-retardant on each of said beads and clumps; and
a binder material comprising latex paint holding together said beads and clumps coated with intumescent fire-retardant in a self-supporting block.

2. A thermal insulation block as in claim 1, wherein said intumescent fire-retardant comprises methyl cellulose.

3. A thermal insulation block as in claim 1, further comprising a flexible polymer bag encasing said self-supporting block.

4. A thermal insulation block as in claim 3, wherein the block comprises no rigid box enclosing the self-supporting block.

5. A thermal insulation block as in claim 1, wherein each of said beads and clumps is 0.1-0.5 inches in diameter.

6. A thermal insulation block as in claim 1, wherein said binder material consists essentially of recycled latex paint.

7. A thermal insulation block as in claim 1, wherein said binder material comprises recycled latex paint and methyl cellulose.

8. A thermal insulation block for wood or metal frame building construction, the block comprising:
recycled polystyrene ground into individual beads and clumps of beads;
a coating of intumescent fire-retardant on each of said individual beads and each of said clump of beads, wherein said intumescent fire-retardant comprises a binder component selected from the group consisting of methyl cellulose, glue, and mixtures of methyl cellulose and glue; and
at least one binder material holding the fire-retardant-covered beads and clumps together in a self-supporting block.

9. A thermal insulation block as in claim 8, further comprising a flexible polymer bag encasing said self-supporting block.

10. A thermal insulation block as in claim 8, comprising no rigid box enclosing the self-supporting block.

11. A thermal insulation block as in claim 8, wherein each of said beads and clumps is 0.1-0.5 inches in diameter.

12. A thermal insulation block as in claim 8, wherein said binder material consists essentially of recycled latex paint.

13. A thermal insulation block as in claim 8, wherein said binder material comprises recycled latex paint and methyl cellulose.

14. A loose-fill thermal insulation product for wood or metal frame construction, the product comprising:
ground recycled polystyrene comprising polystyrene beads and clumps;
a coating of intumescent fire-retardant on each of said beads and clumps; and
a binder mixed with said fire-retardant-covered beads and clumps when the beads and clumps are loose-filled into a wall cavity between wall studs, wherein said binder comprises recycled latex paint.

15. A loose-fill thermal insulation product as in claim 14, wherein said intumescent fire-retardant comprises methyl cellulose.

16. A method of making a thermal insulation block for use in wood or metal frame construction, the method comprising:
grinding waste polystyrene into individual beads and clumps of beads;
coating each of said individual beads and each of said clumps of beads with fire-retardant;
binding together said individual beads and said clumps of beads into a self-supporting block by mixing at least one binder material with the fire-retardant-covered beads and clumps to form a mixture, wherein said at least one binder material comprises recycled latex paint;
compressing and allowing the mixture to dry to form a self-supporting block; and
encasing each self-supporting blocks in a flexible plastic bag.

17. A method as in claim 16, wherein said fire-retardant is an intumescent fire-retardant.

18. A method as in claim 17, wherein said coating with fire-retardant comprises mixing said individual beads and clumps of beads with intumescent fire-retardant in a continuous turbine mixer.

19. A method as in claim 17, wherein said intumescent fire-retardant comprises a binder component for holding the fire-retardant on said individual beads and said clumps, and the binder component is selected from the group consisting of: methyl cellulose, glue, and methyl cellulose combined with glue.

20. A method as in claim 17, wherein said coating is done in a continuous turbine mixer.

21. A method as in claim 17, wherein said compressing is done in a baler.
